(19) United States
(12) Patent Application Publication
(10) Pub. No.: US 2023/0382425 A1
(43) Pub. Date: Nov. 30, 2023

(54) END-TO-END SELF-CONTROLLED SECURITY IN AUTONOMOUS VEHICLES

(71) Applicant: Huawei Technologies Co., Ltd., Shenzhen (CN)

(72) Inventors: Jian Li, Waltham, MA (US); Han Su, Ann Arbor, MI (US)

(73) Assignee: Huawei Technologies Co., Ltd., Shenzhen (CN)

(21) Appl. No.: 18/450,512

(22) Filed: Aug. 16, 2023

Related U.S. Application Data
(63) Continuation of application No. PCT/US2021/018614, filed on Feb. 18, 2021.

(51) Int. Cl. B60W 60/00

(52) U.S. Cl. CPC B60W 60/00188; B60W 2420/52; B60W 2420/42; B60W 2420/54; B60W 2420/50

(57) ABSTRACT

Techniques are presented to improve the security of operation for autonomously driving automobiles and other transportation or robotic equipment with varying degrees of autonomous operation. This can include an end-to-end closed-system support of control sensors' own signal emission and self-controlled frequency or polarization, which can be hard to decipher by external attackers. The control systems can employ majority voting by multiple perception results from both time (e.g., samples from same polarization in time series of an epoch, given the fact of oversampling) and space (e.g., different polarizations or sensor types) domains for enhanced security.

### PRIORITY CLAIM

This application is a continuation of PCT Patent Application No. PCT/US2021/018614, entitled, “End-to-End Self-Controlled Security in Autonomous Vehicles,” filed Feb. 18, 2021, by Li et al., which is incorporated by reference herein in its entirety.

### FIELD

The following is related generally to the field of autonomously operating systems and, more specifically, to autonomous driving vehicles.

### BACKGROUND

Automobiles and other vehicles are becoming more autonomous, as both fully autonomous vehicles (AVs) and in systems of varying degrees of autonomous operation to assist a driver or operator. These systems rely on inputs from sensors, such as cameras receptive to light in the visible spectrum or lidar based sensors, for example. Processors on the vehicle use the inputs from these sensor systems to determine control inputs for control systems of the vehicle, such as for steering and braking. If these sensors systems incorrectly sense the environment within which the vehicle is operating, whether through misperception or by being intentionally spoofed, incorrect control inputs may be determined, and the control systems can operate the vehicle in error with possibly catastrophic results. As the numbers of such AVs, and the number of autonomous systems within even vehicles that are not fully autonomous, increases, it is important to improve the reliability and security of such systems.

### SUMMARY

According to one aspect of the present disclosure, an autonomous vehicle includes: an electro-mechanical control system configured to receive control inputs and control operation of the autonomous vehicle in response; a sensor system configured to emit multiple modalities of an electromagnetic sensor signal over a period of time during which the autonomous vehicle is in operation and to sense the multiple modalities the electromagnetic sensor signal over the period of time; and one or more processing circuits connected to the electro-mechanical control system and the sensor system. The one or more processing circuits are configured to: receive, from the sensor system, the multiple modalities of the electromagnetic sensor signal as sensed over the period of time; generate, from the multiple modalities of the electromagnetic sensor signal as sensed over the period of time, an intermediate output for each of the modalities for a plurality of sub-intervals of the period; compare the intermediate outputs of different ones of the multiple modalities for each of the plurality of sub-intervals; compare each of modalities of the intermediate outputs for the plurality of sub-intervals; and, based on a combination of comparing the intermediate outputs of different ones of the multiple modalities for each of the plurality of sub-intervals and comparing each of modalities of the intermediate outputs for the plurality of sub-intervals, generate and provide the control inputs to the electro-mechanical control system.

Optionally, in the preceding aspect, the one or more processing circuits are further configured to determine the emitted modalities of the electromagnetic sensor signal based on the multiple modalities of the electromagnetic sensor signal as sensed over the period of time.

Optionally, in either of the preceding aspects, in comparing the intermediate outputs of different ones of the multiple modalities for each of the plurality of sub-intervals and in comparing each of modalities of the intermediate outputs for the plurality of sub-intervals, the one or more processing circuits are configured to perform majority voting operations between the intermediate outputs.

Optionally, in any of the preceding aspects, the comparing of the intermediate outputs of different ones of the multiple modalities for each of the plurality of sub-intervals and comparing of each of modalities of the intermediate outputs for the plurality of sub-intervals are performed in a single processor of the one or more processing circuits.

Optionally, in any of the preceding aspects, the multiple modalities of the electromagnetic sensor signal include different polarizations of the electromagnetic sensor signal.

Optionally, in any of the preceding aspects, the multiple modalities of the electromagnetic sensor signal include different frequencies of the electromagnetic sensor signal.

Optionally, in any of the preceding aspects, the multiple modalities of the electromagnetic sensor signal include different encodings of the electromagnetic sensor signal.

Optionally, in any of the preceding aspects, the electromagnetic sensor signal is a lidar signal.

Optionally, in any of the preceding aspects, the electromagnetic sensor signal is a radar signal.

Optionally, in any of the preceding aspects, the sensor system includes a visual spectrum camera system.

Optionally, in any of the preceding aspects, the sensor system configured to emit multiple modalities of a sonar signal.

Optionally, in the preceding aspect, the multiple modalities of the sonar signal include different frequencies.

Optionally, in any of the preceding aspects, the electro-mechanical control system includes a steering control system for the autonomous vehicle.

Optionally, in any of the preceding aspects, the electro-mechanical control system includes a speed control system for the autonomous vehicle.

According to an additional aspect of the present disclosure, there is provided a method of controlling an autonomous system that includes: emitting, from a sensor system, multiple modalities of an electromagnetic sensor signal over a period of time during which the autonomous system is in operation; sensing, by the sensor system, the multiple modalities of the electromagnetic sensor signal over the period of time; receiving, at one or more processing circuits from the sensor system, the corresponding multiple modalities of the electromagnetic sensor signal as sensed over the period of time; and generating, by the one or more processing circuits from the multiple modalities of the electromagnetic sensor signal as sensed over the period of time, an intermediate output for each of the modalities for a plurality of sub-intervals of the period. The method further includes: comparing, by the one or more processing circuits, the intermediate outputs of different ones of the multiple modalities for each of the plurality of sub-intervals; comparing, by the one or more processing circuits, each of modalities of the intermediate outputs for the plurality of sub-intervals; generating, by the one or more processing circuits from a combination of comparing the intermediate outputs of different ones of the multiple modalities for each of the plurality of sub-intervals and comparing each of modalities of the intermediate outputs for the plurality of sub-intervals, control inputs for an electro-mechanical control system; providing the control inputs to the electro-mechanical control system; and controlling of the autonomous system by the electro-mechanical control system in response to the control inputs.

Optionally, in the preceding aspect of a method, the method further includes determining the emitted modalities of the electromagnetic sensor signal based on the multiple modalities of the electromagnetic sensor signal as sensed over the period of time.

Optionally, in any of the two preceding aspects of a method, comparing the intermediate outputs of different ones of the multiple modalities for each of the plurality of sub-intervals includes performing a majority voting between the different ones of the multiple modalities for each of the plurality of sub-intervals; and comparing each of modalities of the intermediate outputs for the plurality of sub-intervals includes performing a majority voting between the modalities of the intermediate outputs for the plurality of sub-intervals.

Optionally, in any of the preceding aspects of a method, comparing the intermediate outputs of different ones of the multiple modalities for each of the plurality of sub-intervals, comparing each of modalities of the intermediate outputs for the plurality of sub-intervals, and generating control inputs for an electro-mechanical control system are performed in a single processor of the one or more processing circuits.

Optionally, in any of the preceding aspects of a method, the multiple modalities of the electromagnetic sensor signal include different polarizations of the corresponding sensor signal.

Optionally, in any of the preceding aspects of a method, the multiple modalities of the electromagnetic sensor signal include different frequencies of the corresponding sensor signal.

Optionally, in any of the preceding aspects of a method, the multiple modalities of the electromagnetic sensor signal include different encoding of the corresponding sensor signal.

Optionally, in any of the preceding aspects of a method, the electromagnetic sensor signal includes a lidar signal.

Optionally, in any of the preceding aspects of a method, the electromagnetic sensor signal includes a radar signal.

Optionally, in any of the preceding aspects of a method, the electromagnetic sensor signal includes a visual spectrum signal.

Optionally, in any of the preceding aspects of a method, the method further includes emitting by the sensor system of multiple modalities of a sonar signal.

Optionally, in the preceding aspect of a method, the multiple modalities of the sonar signal include different frequencies.

Optionally, in any of the preceding aspects of a method, the autonomous system is an autonomous vehicle and controlling of the autonomous system by the electro-mechanical control system in response to the control inputs includes controlling a steering system for the autonomous system.

Optionally, in any of the preceding aspects of a method, the autonomous system is an autonomous vehicle and controlling of the autonomous system by the electro-mechanical control system in response to the control inputs includes controlling a speed control system for the autonomous system.

According to other aspects, a control system for autonomously operable equipment includes one or processing circuits configured to: receive, from a sensor system, multiple modalities of each of a plurality of sensor signals as sensed over a period of time; perform, for each of the corresponding multiple modalities the corresponding sensor signals as sensed over the period of time, majority voting between the multiple modalities for each of a plurality of sub-intervals of the period and majority voting for each of the multiple modalities between different times of the period; and, based on a combination of the majority voting between the multiple modalities for each of the sub-intervals and the majority voting for each of the multiple modalities between differ times of the period for each of the corresponding sensor signal voting, generate and provide control inputs for an electro-mechanical control system for the autonomously operable equipment.

In the preceding aspect for a control system for autonomously operable equipment, the control system can further include the electro-mechanical control system, wherein the electro-mechanical control system is configured to receive the control inputs and to control the operation of the autonomously operable equipment in response thereto.

In any of the preceding aspects for a control system for autonomously operable equipment, the control system can further include the sensor system, wherein each of the sensor system is configured to emit the multiple modalities of the sensor signals over the period of time during which the autonomously operable equipment is in operation and to sense the multiple modalities the sensor signals over the period of time.

In any of the preceding aspects for a control system for autonomously operable equipment, the one or more processing circuits are further configured to determine the emitted modalities of the electromagnetic sensor signal based on the multiple modalities of the electromagnetic sensor signal as sensed over the period of time.

In any of the preceding aspects for a control system for autonomously operable equipment, the multiple modalities of the corresponding sensor signal include different polarizations of the corresponding sensor signal.

In any of the preceding aspects for a control system for autonomously operable equipment, the multiple modalities of the corresponding sensor signal include different frequencies of the corresponding sensor signal.

In any of the preceding aspects for a control system for autonomously operable equipment, the multiple modalities of the corresponding sensor signal include different encoding of the corresponding sensor signal.

In any of the preceding aspects for a control system for autonomously operable equipment, the sensor system includes a lidar system.

In any of the preceding aspects for a control system for autonomously operable equipment, the sensor system includes a radar system.

In any of the preceding aspects for a control system for autonomously operable equipment, the sensor system includes a visual spectrum camera system.

In any of the preceding aspects for a control system for autonomously operable equipment, the sensor system includes a sonar system.

In any of the preceding aspects for a control system for autonomously operable equipment, the autonomously operable equipment is an autonomous vehicle.

In any of the preceding aspects for a control system for autonomously operable equipment, the autonomously operable equipment is robotic equipment.

### BRIEF DESCRIPTION OF THE DRAWINGS

Aspects of the present disclosure are illustrated by way of example and are not limited by the accompanying figures for which like references indicate elements.

FIG. 1 is a block diagram illustrating some of the elements that can be incorporated into a generic autonomous vehicle system.

FIG. 2 is a schematic representation of a lidar sensor system for an autonomous vehicle.

FIG. 3 illustrates passive and active attacks on an autonomous vehicle's sensors.

FIG. 4 is a block diagram of an autonomous vehicle system that incorporates end-to-end self-controlled and secure transmission and reception of sensor signals.

FIG. 5 is a schematic representation of a lidar sensor system for an autonomous vehicle that uses multiple polarizations.

FIG. 6 is a flow chart for an embodiment for the providing end-to-end self-controlled security of an autonomous vehicle described with reference to FIGS. 4 and 5.

FIG. 7 is a more detailed flow of an embodiment for the self-controlled and secure transmit and receive of multi-modal sensor signals.

FIG. 8 presents a more detailed flow for an embodiment of time-space-domain majority voting.

FIG. 9 illustrates triple modular redundant architecture, in which three CPUs are run in parallel in a lockstep manner and the resultant outputs are compared.

FIG. 10 is a high-level block diagram of a more general computing system that can be used to implement various embodiments described in the preceding figures.

### DETAILED DESCRIPTION

The following presents techniques to improve the security of operation for autonomously driving automobiles and other transportation or robotic equipment with varying degrees of autonomous operation. This can include an end-to-end closed-system support of control sensors' own signal emission and self-controlled frequency or polarization, which can be hard to decipher by external attackers. The control systems can employ majority voting by multiple perception results from both time (e.g., samples from same polarization in time series of an epoch, given the fact of oversampling) and space (e.g., different polarizations or sensor types) domains for enhanced security.

It is understood that the present embodiments of the disclosure may be implemented in many different forms and that claims scopes should not be construed as being limited to the embodiments set forth herein. Rather, these embodiments are provided so that this disclosure will be thorough and complete and will fully convey the inventive embodiment concepts to those skilled in the art. Indeed, the disclosure is intended to cover alternatives, modifications and equivalents of these embodiments, which are included within the scope and spirit of the disclosure as defined by the appended claims. Furthermore, in the following detailed description of the present embodiments of the disclosure, numerous specific details are set forth in order to provide a thorough understanding. However, it will be clear to those of ordinary skill in the art that the present embodiments of the disclosure may be practiced without such specific details.

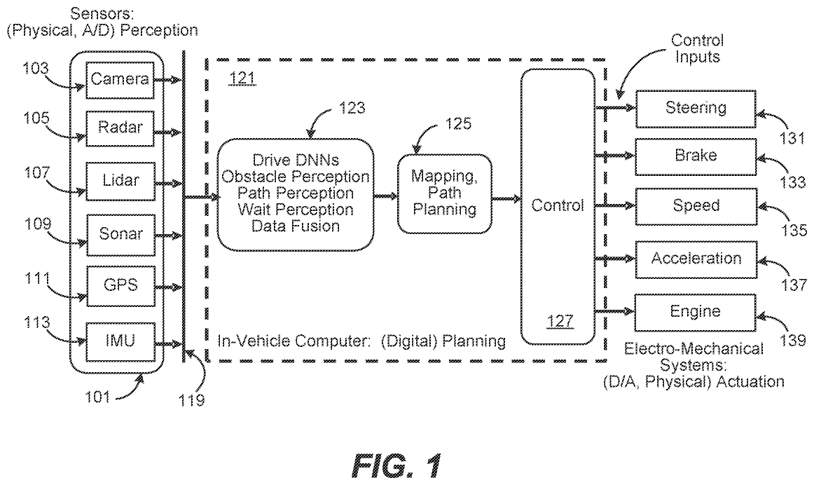

FIG. 1 is a block diagram illustrating some of the elements that can be incorporated into a generic autonomous vehicle system. Depending on the particular embodiment, the system may not contain all of the elements shown in FIG. 1 and may also include additional elements not shown in FIG. 1. The following discussion will mainly be presented in the context of an autonomously operating automobile, but can also apply to other vehicles or robotic systems and to varying degrees of autonomy. For example, many current non-autonomous vehicles employ driver assist systems that can apply many of the techniques described here, such as a radar or lidar based system that monitors the distance to another car and provides warnings to the driver.

The autonomous vehicle of FIG. 1 includes a set of sensors 101 that the vehicle uses to perceive the environment through which it moves or operates in. These sensors receive physical signals, typically in an analog form, that can then be converted into a digital form through analog to digital (A/D) converters before supplying their output to the processing circuitry of the in-vehicle computer 121. One of the sensors can be a camera system 103 that can sense light in or near (e.g., infrared) the visible spectrum. Depending on the embodiment, the camera system 103 can be a single camera or multiple camera, such as located to have differing fields of view or being sensitive to different frequencies of the visible or near visible portions of the electromagnetic spectrum. The camera system 103 will sense light present in the environment, but also light from the AV itself, such as from headlights or, in some cases, light emitted specifically for the use of the camera system 103 itself.

The sensors 101 can also have other systems that make use of the electromagnetic spectrum, such as a radar system 105 or lidar system 107. The radar system 105 can include one or more transmitters producing electromagnetic waves in the radio or microwaves domain, one or more transmitting antennas, and one or more receiving antennas, where the same antenna can be used for both transmitting and receiving in some embodiments. The lidar system 107 can be used to measure distances (ranging) by use of transmitting laser light and measuring the reflections. Differences in laser return times and wavelengths can then be used to determine a three dimensional representation of the autonomous vehicle's environment. A sonar system 109 can use sound waves to provide information on the autonomous vehicle's environment. The radar system 105, lidar system 107, and sonar system 109 will typically emit signals as well as monitor received signals.

The sensors 101 can also include a GPS system 111 that receives signals from global positioning satellites (GPS) or, more generally, global navigation satellite systems (GNSS) that provide geolocation and time information. The sensors can also include inertial measurement units (IMU) 113, such as accelerometers, that can be used to detect movement of the autonomous vehicle.

The outputs from the sub-systems of the sensors 101 are then provided to the in-vehicle computer systems 121 over a bus structure 119 for the autonomous vehicle. The in-vehicle computer systems 121 can include a number of digital processors (CPUs, GPUs, etc.) that then process the inputs from the sensors 101 for planning the operation of the autonomous vehicle, which are translated into the control inputs for the electrical-mechanical systems used to control the autonomous vehicle's operation. In this schematic representation, the one or more processing units of the in-vehicle computer systems 121 include a block 123 for major processing of the inputs from the sensors 101, including deep neural networks (DNNs) for the driving operations, including: obstacle perception, for determining obstacles in the AV's environment; path perception, for determining the vehicle's path; wait perception, for determining the rate of progression along the path; and data fusion, that assembles and collates the various perception results. A mapping and path planning block 125 is configured to take the inputs from the DNN block 123 and determine and map the autonomous vehicle's path, which is then used in the control block 127 to generate the control signal inputs provided to the electro-mechanical systems used to operate the autonomous vehicle or system. Although broken down into the blocks 123, 125, and 127 in FIG. 1, the one or more processors corresponding to these blocks can perform functions across multiple ones of the blocks.

The control inputs from the in-vehicle computer 121 provides control inputs to the electro-mechanical systems used to control the operation of the autonomous vehicle. Each of these electro-mechanical systems receives a digital input from the in-vehicle computer 121, which is typically converted by each of the systems to an analog signal by a digital to analog (D/A) conversion to generate an analog signal used for actuators, servos, or other mechanisms to control the vehicles operation. The control systems can include steering 131; braking 133; speed control 135; acceleration control 137; and engine monitoring 139.

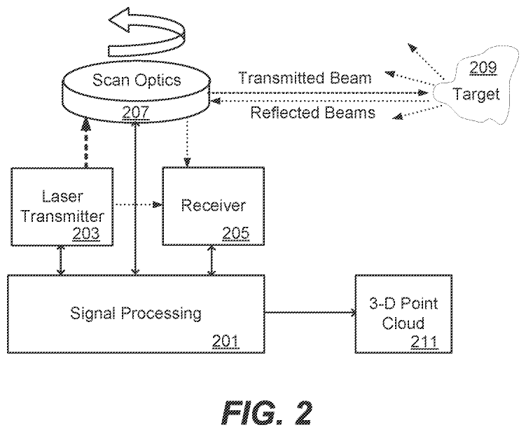

As noted above, many of the systems for the sensors 101 are both signal generators and signal sensors. This is true of the radar system 105, the lidar system 107, and the sonar system 109. This can also be true of the camera system 103, where this can be used to receive light present in the environment, but the system can also be a generator of signals in the visible or near visible electromagnetic spectrum, such as by emitting infra-red light signals or even through the headlights when operating at night or low light situations. As these systems are both signal generators and receivers (or consumers), they can be used as part of a feedback loop for controlling of an autonomous operated system. FIG. 2 looks at the example of the lidar system 107.

FIG. 2 is a schematic representation of a lidar sensor system for an autonomous vehicle. Lidar is light detection and ranging, or laser imaging, detection, and ranging system is a combination of laser scanning and three dimensional scanning that can be used to generate a 3-D image of the environment about the autonomous vehicle. A signal processing block 201, such as can be formed of one or more processors, can control a laser transmitter 203 that provides a laser to scan optics 207 and transmit the lidar signal to the environment about the autonomous vehicle. This is commonly a rotating transmitter (as indicated by the arrow) mounted on an autonomous vehicle. The same scan optics 207 can also be the receiver or, alternately or additionally, one or more additional receivers can be mounted on the autonomous vehicle.

The beam transmitted from the scan optics will reflect off of objects, such as target 209, in the vicinity of the autonomous vehicle as a reflected beam. The reflected beam is then received at the scan optics 207 and/or other lidar sensor, with the result then supplied to the receiver 205, which also receives input from the laser transmitter 203. Based on comparing the transmitted and received signals supplied to the receiver 205, the result is supplied to the signal processing 201. This data can then be used to generate an image, or 3-D point cloud, of the obstacles in the vicinity of the autonomous vehicle by the DNNs 123 of the in-vehicle computer 121. The neural networks of 123 can then generate a three dimensional point cloud 211 of objects in the environment that can then be used by the mapping, path planning block 125. Consequently, the systems of FIG. 1 have the capability to control the whole signal data life cycle, from generation, transmission to consumption and analytics, i.e., end-to-end. This is the case of the radar system 105, lidar system 107, and sonar system 109, as these emit the signals that they then sense, but it can also be the case with the camera system 103 that can emit signals in the infrared or visual spectrum or encode headlight signals, for example, in order to distinguish between signals emitted by the autonomous vehicle itself and not from another source.

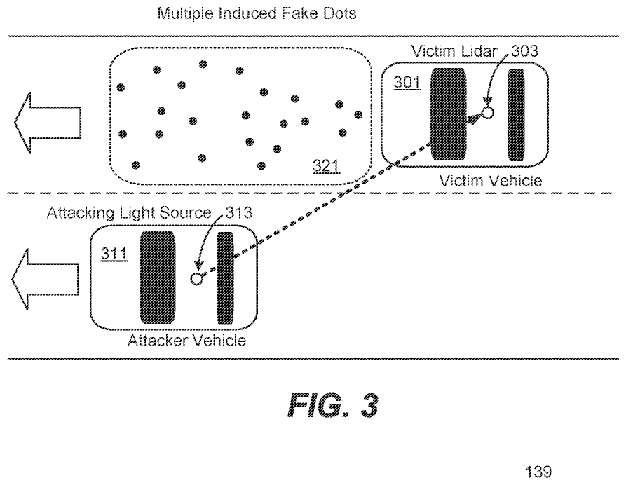

Conventional control systems for controlling of autonomous vehicles are insecure and can be easy to spoof, whether accidentally or intentionally, which can lead to accidents or other less dangerous, but still unwarranted operation. This can be illustrated in FIG. 3.

FIG. 3 illustrates passive and active attacks on an autonomous vehicle's sensors. FIG. 3 shows a two-lane road with a first autonomous (victim) vehicle 301 in the right hand lane moving towards the left. The victim vehicle 301 can include sensors like those illustrated in FIG. 1, including a camera system or lidar system 303. Somewhat ahead of the victim vehicle 301 is a second autonomous (attacker) vehicle 311 in the left hand lane moving to left. The attacker vehicle 311 also has sensor systems, including a lidar system 313. Light emitted from the scan optics of the lidar system 313 of the attacker vehicle 311 may be received by the lidar system 303 of the victim vehicle 301, where they may be mistaken for a reflected beam for light transmitted by the lidar system 303 of the victim vehicle 301 itself. This could be either an intentional attack by the attacker vehicle 311 meant to spoof the systems of the victim vehicle or an unintentional consequence of the standard operation of the attacker vehicle's lidar system 313. In either case, the light of the attacking light source of lidar system 313 as received by the lidar system 303 of the victim vehicle 301 will receive erroneous or misleading sensor inputs, leading the in-vehicle computer 121 to generate incorrect control inputs for the electro-mechanical systems used to control the operation of the autonomous vehicle 301, leading to improper operation or even an accident.

In another example, a number of “fake” dots 321 of light, which can be intentionally induced, or just arise in the environment, may be mistaken by the camera system 103 as a physical object. For example, when operating at night, dots or other shapes of transmitted light may be mistaken for a physical object reflecting back light from the headlights of victim vehicle 301, again confusing its control systems.

To address such perception induced security holes, the following discussion introduces end-to-end self-controlled security into autonomous vehicles and other autonomous systems. As an autonomous vehicle is itself both a signal generator and a consumer of lidar, radar, and other systems, this allows it to operate these signals in a feedback loop. The following exploits the capability to control the whole signal data life cycle, from generation, transmission, to consumption and analytics, i.e., end-to-end. This can be illustrated by referring back to lidar example of FIG. 2, where the signal from the laser transmitter is supplied to the scan optics 207, which emits the transmitted beam and receives the reflected beam, where the transmitted and received beams can then be compared by the receiver. Controlling of the modalities of the sensor signals (such as frequency and polarization (with varied angles) for electromagnetic waves, frequency for sonar, or other encoding) offers additional controllability for such a self-controlled framework.

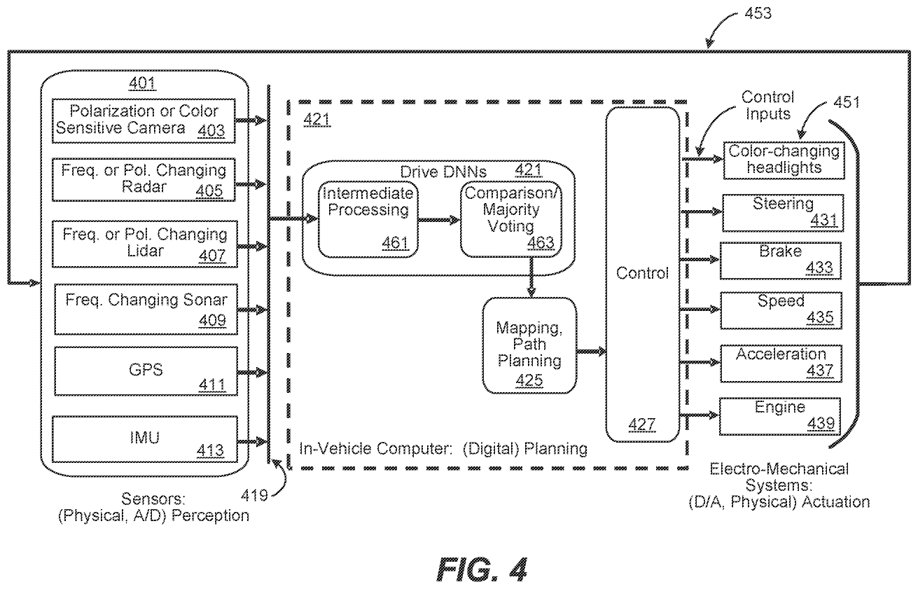

FIG. 4 is a block diagram of an autonomous vehicle system that incorporates end-to-end self-controlled and secure transmission and reception of sensor signals. The use of different modalities for sensor signals allows for majority voting in both the time domain, where the same modality is compared at different times, and the space domain, where different modalities of the same signal for the same time periods are compared.

FIG. 4 is structured similarly to FIG. 1, repeating many of the elements that are similarly numbered. The sensors 401 are again shown to include a camera system 403 operating in the visible or near visible spectrum, radar system 405, lidar system 407, sonar system 409, GPS system 411, and IMU system 413. For the GPS system 411 and IMU system 413, these can be as described above for respective elements 111 and 113 of FIG. 1. For the other systems, however, one or more of these can operate in multiple modalities for transmitting and sensing of their corresponding signals. These different modalities can include use of multiple frequencies (color in the context of camera system 403), different polarizations for the electromagnetic sensor systems (camera system 403, radar system 405, lidar system 407), encoding of the signals (such as by introducing pseudo-random noise digital signals), or some combination of these. Although the camera system 403 senses light present in the environment, in some embodiments it can also emit light from the autonomous vehicle, such as through headlights 451 that could be color changing, for example, or otherwise emitting light in portions of the visible or near visible (i.e., infrared) portions of the electromagnetic spectrum.

The multi-modal outputs from the sub-systems of the sensors 401 are then provided to the in-vehicle computer systems 421 over bus structure 419 for the autonomous vehicle. The in-vehicle computer systems 421, including control block 427 and the mapping, path planning block 425, can largely be as described above, except now the multiple modalities are used in computing the control inputs for the electro-mechanical systems. The deferent modalities can undergo some initial processing to generate an intermediate output, after which the intermediate outputs can be compared to each other, such as in a majority voting operation. The result of the majority vote can then be used for subsequent processing. The amount of initial processing performed to generate the intermediate results used for the majority vote or other comparison can vary depending on the embodiment. For example, a 3-D point cloud could be generated for each of the modalities or the comparison could be performed at an earlier stage. This process is represented schematically within the Drive DNNs 421, where it is schematically represented by the intermediate processing block 461 that receives the modalities from the bus structure 419 and generates the intermediate results, which then go the comparison/majority voting block 463, the result of which is then subsequently used to generate the control inputs for the electro-mechanical systems.

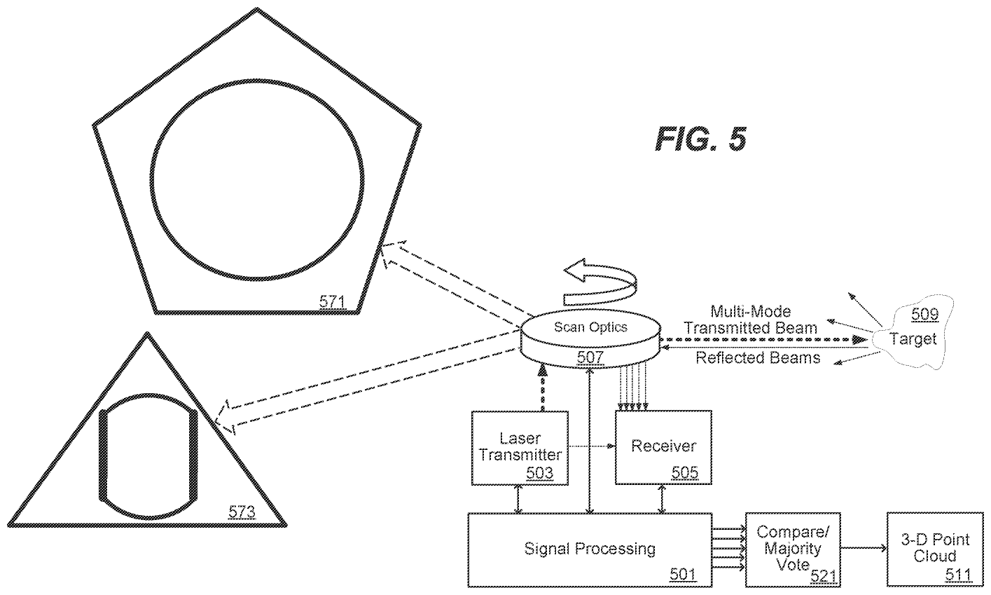

As systems of the sensors 401 can control the signals they send out as well as monitor these signals as they are reflected off of the surrounding environment, this can be exploited in a feedback loop, as illustrated at 453. This arrangement can provide end-to-end security through use of these sensor technologies, such as employing frequency or polarization control, in autonomous driving from one or multiple types of devices, such as lidar, radar, ultrasound (i.e., sonar), visual spectrum camera (such as through the headlights and camera), and so on. Under this arrangement, the sensors' own signal emissions can use self-controlled varied frequencies/wavelengths or polarization via automated lens/filter, which is hard to decipher by external attackers. The voting by multiple perception results from both time (i.e., samples from same electromagnetic wave frequency or polarization in time series of a sub-interval (“epoch”) during operation, given the fact of oversampling) and space (different polarizations or sensor types) domains, can thus provide enhanced security. FIG. 5 illustrates the multi-modality approach as applied to a lidar system and multiple polarizations.

FIG. 5 is a schematic representation of a lidar sensor system for an autonomous vehicle that uses multiple polarizations. FIG. 5 is arranged similarly to FIG. 2 and uses similar numbering, but now incorporates the use of multiple modalities and majority voting. A laser transmitter 503 again provides the laser light to the scan optics 507 that emits the transmitted beam. Relative to FIG. 2, the transmitted beam now is transmitted with multiple polarizations. Alternately or additionally, the laser can emit multiple frequencies. In some embodiments, the polarizing elements can be a “plug-n-play” arrangement, such as a rigid glass or flexible film of different polarization angles mounted around existing scan optics of lidar system to achieve single-source multi-modality. To avoid an ambiguous result (i.e., a tie), the polarizing element can have an odd number of sides, i=[1,N] where N is an odd number, and hence an odd number of polarization options to improve the robustness of majority voting. Although FIG. 5 shows a lidar example, similar arrangements could be applied to transmitted/received signal pairs for radar, sonar, and a camera plus headlight arrangement, for example.

FIG. 5 illustrates two examples of form factors that can be used for the polarizer of the scan optics. The embodiment of polarizer 571 show a top view of a pentagon shape polarizer of 5 angles (which may include a non-polarization one) around the central scan optics for transmitting and receiving the laser beam. The different facets can correspond to different polarization filters. For embodiments using different frequency modalities, each facet could have a different frequency filter, for example. Another possible form factor is illustrated by the triangular form factor 573. The number of different polarizations emitted and received is a design decision, as more polarization angles provide more information, but increase complexity and, as the differences in polarization angles are smaller, the additional information gained incrementally decreases.

The multi-polarization beam as transmitted by the scan optics will then scatter off of objects in the vicinity of the autonomous vehicle, such as represented by target 509, and the beams reflected back are then sensed by the scan optics 507 or other receivers of the system. The multiple sensed modalities can then be supplied to the receiver 505 and passed on for signal processing 501, where this can be as described above with respect to single modality case of FIG. 2, except being done for each of the modalities. The final 3-D point cloud 511 is then generated by the majority vote block 521 based on the intermediate outputs. Depending on the embodiment, different amounts of processing can be done to generate the intermediate output results. For example, this could be computing the full 3-D point cloud 511 for each of the modalities and comparing these, or the comparison could be performed at an earlier stage, where this decision is a trade-off between a fully data set to compare and increased computational complexity.

The arrangement of FIG. 5 for the lidar system, and of other sensor systems of FIG. 4, can thus provide an end-to-end closed-system support to the control sensors' own signal emission with self-controlled varied frequencies/wavelengths or polarization via automated lens/filters, which is hard to decipher by external attackers. The majority voting can be done with multiple perception results from one or both of time (samples from same electromagnetic wave frequency or polarization in time series of an epoch, given the fact of oversampling) and of space (different polarizations or sensor types) domains for enhanced security.

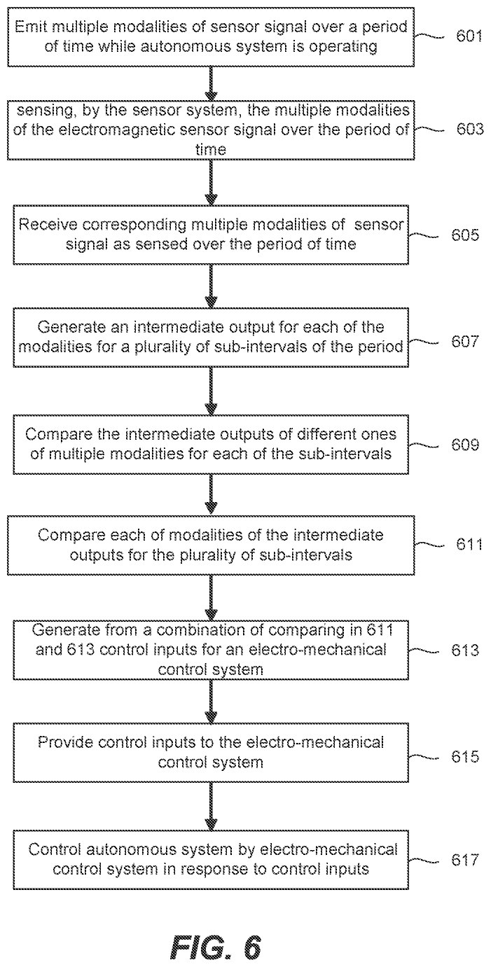

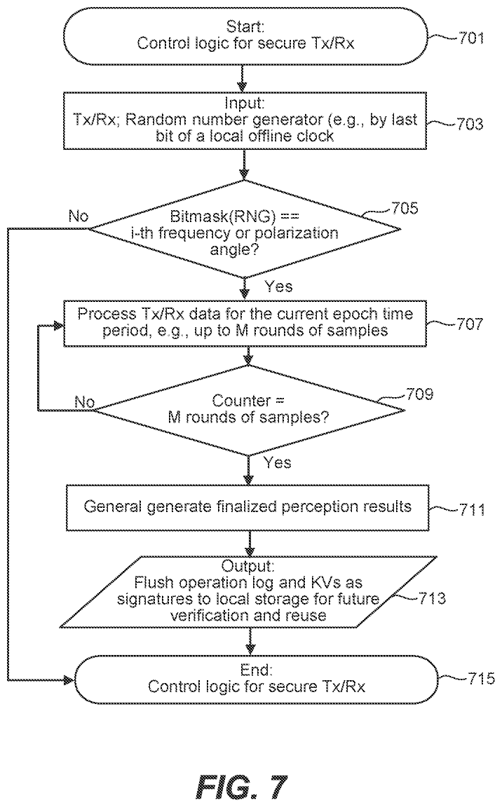

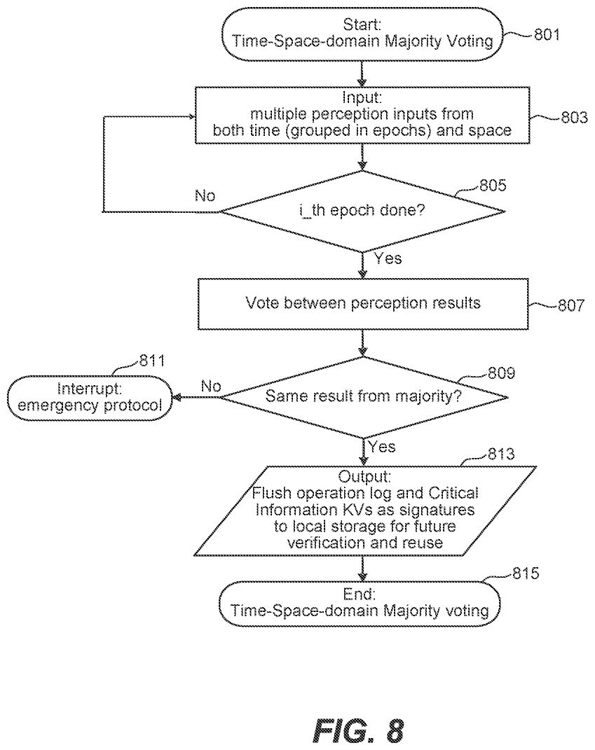

FIG. 6 is a flow chart for an embodiment for the providing end-to-end self-controlled security of an autonomous vehicle as described with reference to FIGS. 4 and 5. FIGS. 7 and 8 provide additional detail relative to the higher level flow of FIG. 6. Staring at 601, one or more of the sensor systems of the sensors 401 emit corresponding signals during a period when the autonomous system is in operation. One or more of the sensor systems emit sensor signals in multiple modalities, where this can include different frequencies, different polarizations for electromagnetic based sensors (or the lidar 407, radar 405, or camera 403 systems), or otherwise using multiple encoding for the signals. Referring to the lidar example of FIG. 5, different polarization can be introduced by the scan optics 507 using the form factors 571 or 573, for example, and different frequencies or encoding for the laser transmitter 503 can be controlled by control circuitry of the signal processing block. The multiple modalities of the emitted signals as reflected by objects in the vicinity of the autonomous system are then sensed at 603 by the corresponding sensor systems.

The multiple modalities of the electromagnetic or other sensor signals are received at one or more processing circuits at 605. In FIG. 5, for example, this can correspond to the receiver 505 and the signal processing circuitry (or parts thereof) 505. These processing circuits then generate intermediate outputs at 607 for the multiple modalities, where it is these intermediate results that will then be used for the comparisons, such as the majority voting. Relative to FIG. 4, the receiver 505 can be part of the lidar system 407 and the signal processing 501 can be variously distributed between the lidar system 407 control circuitry and the intermediate processing 461. The amount of processing done to generate the intermediate results can vary depending on the embodiment, such as generating a 3-D point cloud for each modality or at some earlier stage of processing.

The intermediate mediate outputs of the different modalities are then compared at 609 and 611, with different modalities for the same sub-interval of operation period being compared at 609 and the each of the same modalities being compared at different times at 611. For the main embodiments presented here, this comparison is a majority voting, where this can be done in the comparison/majority voting block 521/463. Although represented as separate block in FIGS. 4 and 5 based on functional grounds and for explanatory purpose, the generation of the intermediate outputs and comparison/majority voting can be executed on different processors or the same processor, where this is again a design choice.

Based on the results of 609 and 611, control inputs are generated for the electro-mechanical systems used for the operation of the autonomous vehicle or other system at 613. As represented in FIG. 4, the control inputs can be generated in the one or more processing circuits involved in mapping, path planning 425 and the control block 427. The control inputs are then provided to the electron mechanical systems (color changing headlights 451, steering 431, braking 433, speed control 435, acceleration control 437, engine monitoring 439) at 615, which are then used at 617 to control the autonomous system at 439. Although shown as a single sequence, it will be understood that, while the autonomous system is in operation, this will be an ongoing process with the steps cycling over the period of operation.

FIG. 7 is a more detailed flow of an embodiment for the self-controlled and secure transmit and receive of multi-modal sensor signals that can used to generate the intermediate outputs used for the subsequent majority voting. In this embodiment, the different frequencies or polarization angles can be activated and controlled in a self-enclosed system, such as a local offline random number generator (RNG) mechanism that controls which angles are active for the transmitter and receiver. The perception results are grouped in sub-intervals, or “epochs”. The flow of FIG. 7 is again in the lidar context where the different modalities are polarizations, but can similarly be applied to radar, sonar, or the camera plus headlight systems.

The flow of FIG. 7 relates to the operation of the control logic operating on the one or more processors of the in-vehicle computer 421 and the control circuitry of, in this example, the lidar system 407 and starts the control logic for the secure multi-modal transmission and reception (Tx/Rx) at 701. In this embodiment, the initial input at 703 for both transmitting and receiving is from a random number generator, such as from the last bit or last several bits of a local offline clock. This is followed at 705 by determining whether current random number value (Bitmask(RNG)) is equal to one of the modality values (e.g., frequency ranges or polarization angles) and, if not, goes to 715 for ending the process.

If the value of the generated random number corresponds to i-th modality, the flow goes to 707 to process the transmitted/received data for the current epoch time period, where this process can be iterated several (M in this example) times. The count is iterated and checked at 709, looping back to 707 until M rounds are completed. Once the set of samples has completed the set of iterations, the final perception results are generated at 711. The output is provided at 713, with the operation log being flushed and the determined data structures, such as key values (KVs), stored as signatures to the local storage for the processor or processors for future verification and reuse, after which the flow ends at 715.

FIG. 8 presents a more detail flow for an embodiment of time-space-domain majority voting between multiple perception inputs from both time (samples from same frequency or polarization in time series, given the fact of oversampling) and space (different polarizations or different senor types) domains for enhanced security. The flow FIG. 8 can again apply to lidar or the other sensor systems of sensors 401 and starts at 801.

The input for the flow of FIG. 8 is received at 803, where this can be the intermediate outputs generated in the flow of FIG. 7 of multiple perception inputs from both time (grouped in epochs) and space. For a given epoch, 805 determines whether all the inputs have been received and, if not, loops back 803. Once done, the flow continues on to the vote between perception results at 807, with 809 determining whether the majority agree. If the majority do not provide the same result, an interrupt is issued at 811 and emergency protocols are instituted. If the majority provide the same result at 809, the output is provided at 813, flushing the operation log and storing critical information key values in local storage for future verification and reuse. The flow then ends at 815.

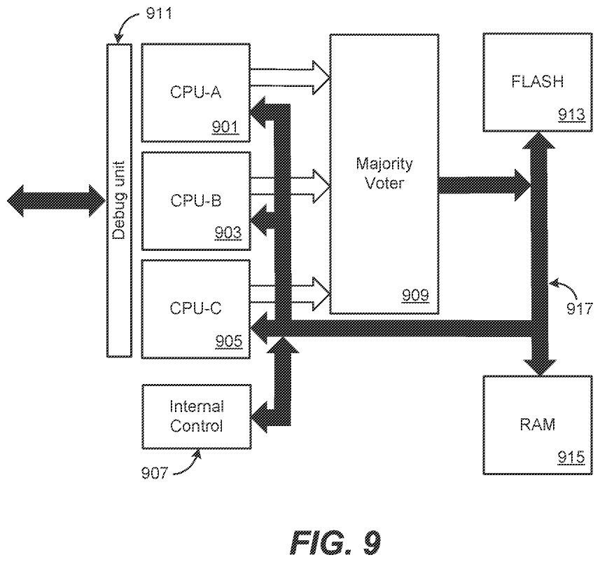

To place the sort of multi-modal majority voting described above in context, it should be noted that, when incorporated into an autonomous vehicles or other autonomous systems, this may be one of a number of other redundancies using comparisons, such as majority voting, between results. For example, the comparisons/majority voting described above looks at such comparisons for individual sensor systems (such as the lidar system 407), but the in-vehicle computer 421 will also compare the results of the different sensor systems of the sensors of 401. Additionally, for systems that require a high degree of reliability, such as autonomous vehicles or other autonomous systems, processor redundancy can be used. FIG. 9 can be used to describe ways in which the multi-modal end-to-end self-controlled security described above can be integrated into a system incorporating processor redundancy.

FIG. 9 illustrates a triple modular redundant architecture in which three CPUs are run in parallel in a lockstep manner and the resultant outputs are compared. This redundancy can provide error detection and correction, as the output from the parallel operations can be compared to determine whether there has been a fault. Each of CPU-A 901, CPU-B 903, and CPU-C 905 are connected to the debug unit 911 and over the bus structure 917 to RAM 915 and to the flash memory 913 or other storage memory for the system, where these components can largely operate in a typical manner. The debug unit 911 can be included to test and debug programs running on the CPUs and allow a programmer to track its operations and monitor changes in resources, such as target programs and the operating system.

CPU-A 901, CPU-B 903, and CPU-C 905 are operated in parallel, running the same programs in a lockstep manner under control of the internal control 907. Each of CPU-A 901, CPU-B 903, and CPU-C 905 can be operated on more or less the same footing and are treated with equal priority. The outputs of the three CPUs go to a majority voter block 909, where the logic circuitry within majority voter 909 compares the outputs. In this way, if the output from one of the CPUs disagrees with the other two, the majority result is provided as the system output from the majority voter 909. Although shown as three CPUs operating in parallel, more generally these can of other processor types, such as graphical processing units GPUs, or parallel multi-processor such systems, such as a set of three CPU-GPU pairs operated in parallel.

It is important to note that the multi-modal majority voting described above is different, and independent of, the multi-processor lockstep majority voting described with respect to FIG. 9. In FIG. 9, multiple processor paths use the same input and operate in parallel with their outputs then being compared in majority voter 909. The process described with respect to FIGS. 1-8 uses multiple different inputs (different polarizations or other modalities) to determine intermediate outputs (FIG. 7), which are then compared as in the majority voting process (FIG. 8). The multi-modal process can be done in a single processor (or processor system). For example, referring to FIG. 9, in one embodiment each of CPU-A 901, CPU-B 903, and CPU-C 905 could independently perform the process described with respect to FIGS. 1-8, where the output from each parallel path then also subjected to the comparison of majority voter 909. In alternate embodiments, the different modalities could be spread across different ones of CPU-A 901, CPU-B 903, and CPU-C 905, where part or all of the majority voting between the modalities could be part of the operation of majority voter 909.

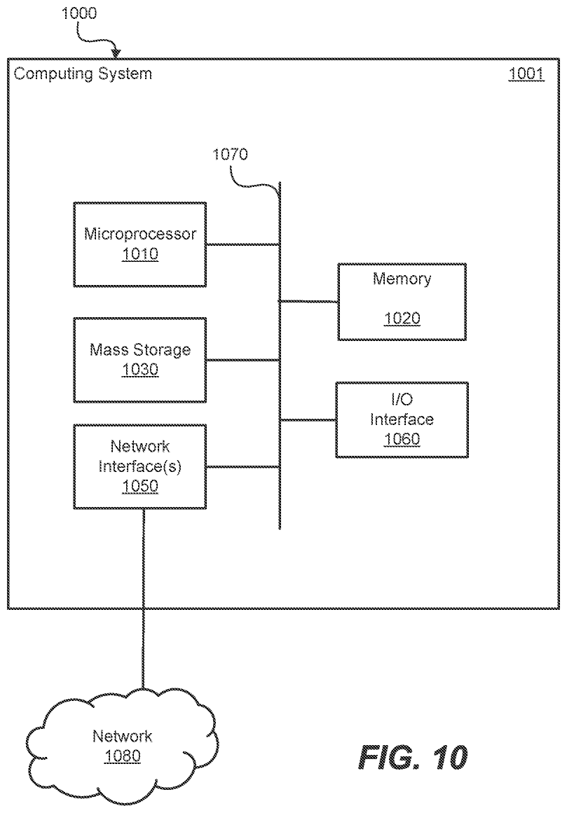

FIG. 10 is a high-level block diagram of one embodiment of a more general computing system 1000 that can be used to implement various embodiments of the processing systems described above. In one example, computing system 1000 is a network system 1000. Specific devices may utilize all of the components shown, or only a subset of the components, and levels of integration may vary from device to device. Furthermore, a device may contain multiple instances of a component, such as multiple processing units, processors, memories, transmitters, receivers, etc.

The network system may comprise a computing system 1001 equipped with one or more input/output devices, such as network interfaces, storage interfaces, and the like. The computing system 1001 may include a central processing unit (CPU) 1010 or other microprocessor, a memory 1020, a mass storage device 1030, and an I/O interface 1060 connected to a bus 1070. The computing system 1001 is configured to connect to various input and output devices (keyboards, displays, etc.) through the I/O interface 1060. The bus 1070 may be one or more of any type of several bus architectures including a memory bus or memory controller, a peripheral bus or the like. The CPU 1010 may comprise any type of electronic data processor, including. The CPU 1010 may be configured to implement any of the schemes described herein with respect to the end-to-end self-controlled security for autonomous vehicles and other autonomous systems of FIGS. 1-9, using any one or combination of elements described in the embodiments. The memory 1020 may comprise any type of system memory such as static random access memory (SRAM), dynamic random access memory (DRAM), synchronous DRAM (SDRAM), read-only memory (ROM), a combination thereof, or the like. In an embodiment, the memory 1020 may include ROM for use at boot-up, and DRAM for program and data storage for use while executing programs.

The mass storage device 1030 may comprise any type of storage device configured to store data, programs, and other information and to make the data, programs, and other information accessible via the bus 1070. The mass storage device 1030 may comprise, for example, one or more of a solid-state drive, hard disk drive, a magnetic disk drive, an optical disk drive, or the like.

The computing system 1001 also includes one or more network interfaces 1050, which may comprise wired links, such as an Ethernet cable or the like, and/or wireless links to access nodes or one or more networks 1080. The network interface 1050 allows the computing system 1001 to communicate with remote units via the network 1080. For example, the network interface 1050 may provide wireless communication via one or more transmitters/transmit antennas and one or more receivers/receive antennas. In an embodiment, the computing system 1001 is coupled to a local-area network or a wide-area network for data processing and communications with remote devices, such as other processing units, the Internet, remote storage facilities, or the like. In one embodiment, the network interface 1050 may be used to receive and/or transmit interest packets and/or data packets in an ICN. Herein, the term “network interface” will be understood to include a port.

The components depicted in the computing system of FIG. 10 are those typically found in computing systems suitable for use with the technology described herein, and are intended to represent a broad category of such computer components that are well known in the art. Many different bus configurations, network platforms, and operating systems can be used.

The technology described herein can be implemented using hardware, firmware, software, or a combination of these. Depending on the embodiment, these elements of the embodiments described above can include hardware only or a combination of hardware and software (including firmware). For example, logic elements programmed by firmware to perform the functions described herein is one example of elements of the described lockstep systems. A CPU and GPU can include a processor, FGA, ASIC, integrated circuit or other type of circuit. The software used is stored on one or more of the processor readable storage devices described above to program one or more of the processors to perform the functions described herein. The processor readable storage devices can include computer readable media such as volatile and non-volatile media, removable and non-removable media. By way of example, and not limitation, computer readable media may comprise computer readable storage media and communication media. Computer readable storage media may be implemented in any method or technology for storage of information such as computer readable instructions, data structures, program modules or other data. Examples of computer readable storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer. A computer readable medium or media does (do) not include propagated, modulated or transitory signals.

Communication media typically embodies computer readable instructions, data structures, program modules or other data in a propagated, modulated or transitory data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as RF and other wireless media. Combinations of any of the above are also included within the scope of computer readable media.

In alternative embodiments, some or all of the software can be replaced by dedicated hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), special purpose computers, etc. For example, some of the elements used to execute the instructions issued in FIG. 2, such as an arithmetic and logic unit (ALU), can use specific hardware elements. In one embodiment, software (stored on a storage device) implementing one or more embodiments is used to program one or more processors. The one or more processors can be in communication with one or more computer readable media/storage devices, peripherals and/or communication interfaces.

It is understood that the present subject matter may be embodied in many different forms and should not be construed as being limited to the embodiments set forth herein. Rather, these embodiments are provided so that this subject matter will be thorough and complete and will fully convey the disclosure to those skilled in the art. Indeed, the subject matter is intended to cover alternatives, modifications and equivalents of these embodiments, which are included within the scope and spirit of the subject matter as defined by the appended claims. Furthermore, in the following detailed description of the present subject matter, numerous specific details are set forth in order to provide a thorough understanding of the present subject matter. However, it will be clear to those of ordinary skill in the art that the present subject matter may be practiced without such specific details.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

For purposes of this document, each process associated with the disclosed technology may be performed continuously and by one or more computing devices. Each step in a process may be performed by the same or different computing devices as those used in other steps, and each step need not necessarily be performed by a single computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An autonomous vehicle, comprising:
an electro-mechanical control system configured to receive control inputs and control operation of the autonomous vehicle in response thereto;
a sensor system configured to emit multiple modalities of an electromagnetic sensor signal over a period of time during which the autonomous vehicle is in operation and to sense the multiple modalities the electromagnetic sensor signal over the period of time; and
one or more processing circuits connected to the electro-mechanical control system and the sensor system and configured to:
receive, from the sensor system, the multiple modalities of the electromagnetic sensor signal as sensed over the period of time;
generate, from the multiple modalities of the electromagnetic sensor signal as sensed over the period of time, an intermediate output for each of the modalities for a plurality of sub-intervals of the period;
compare the intermediate outputs of different ones of the multiple modalities for each of the plurality of sub-intervals;
compare each of modalities of the intermediate outputs for the plurality of sub-intervals; and
based on a combination of comparing the intermediate outputs of different ones of the multiple modalities for each of the plurality of sub-intervals and comparing each of modalities of the intermediate outputs for the plurality of sub-intervals, generate and provide the control inputs to the electro-mechanical control system.

2. The autonomous vehicle of claim 1, wherein the one or more processing circuits are further configured to determine the emitted modalities of the electromagnetic sensor signal based on the multiple modalities of the electromagnetic sensor signal as sensed over the period of time.

3. The autonomous vehicle of claim 1, wherein, in comparing the intermediate outputs of different ones of the multiple modalities for each of the plurality of sub-intervals and in comparing each of modalities of the intermediate outputs for the plurality of sub-intervals, the one or more processing circuits are configured to perform majority voting operations between the intermediate outputs.

4. The autonomous vehicle of claim 1, wherein the comparing of the intermediate outputs of different ones of the multiple modalities for each of the plurality of sub-intervals and comparing of each of modalities of the intermediate outputs for the plurality of sub-intervals are performed in a single processor of the one or more processing circuits.

5. The autonomous vehicle of claim 1, wherein the multiple modalities of the electromagnetic sensor signal include different polarizations of the electromagnetic sensor signal.

6. The autonomous vehicle of claim 1, wherein the multiple modalities of the electromagnetic sensor signal include different frequencies of the electromagnetic sensor signal.

7. The autonomous vehicle of claim 1, wherein the multiple modalities of the electromagnetic sensor signal include different encodings of the electromagnetic sensor signal.

8. The autonomous vehicle of claim 1, wherein the electromagnetic sensor signal is a lidar signal.

9. The autonomous vehicle of claim 1, wherein the electromagnetic sensor signal is a radar signal.

10. The autonomous vehicle of claim 1, wherein the sensor system includes a visual spectrum camera system.

11. The autonomous vehicle of claim 1, wherein the sensor system configured to emit multiple modalities of a sonar signal.

12. The autonomous vehicle of claim 11, wherein the multiple modalities of the sonar signal include different frequencies.

13. The autonomous vehicle of claim 1, wherein the electro-mechanical control system includes a steering control system for the autonomous vehicle.

14. The autonomous vehicle of claim 1, wherein the electro-mechanical control system includes a speed control system for the autonomous vehicle.

15. A method of controlling an autonomous system, comprising:
emitting, from a sensor system, multiple modalities of an electromagnetic sensor signal over a period of time during which the autonomous system is in operation;
sensing, by the sensor system, the multiple modalities of the electromagnetic sensor signal over the period of time;
receiving, at one or more processing circuits from the sensor system, the corresponding multiple modalities of the electromagnetic sensor signal as sensed over the period of time;
generating, by the one or more processing circuits from the multiple modalities of the electromagnetic sensor signal as sensed over the period of time, an intermediate output for each of the modalities for a plurality of sub-intervals of the period;
comparing, by the one or more processing circuits, the intermediate outputs of different ones of the multiple modalities for each of the plurality of sub-intervals;
comparing, by the one or more processing circuits, each of modalities of the intermediate outputs for the plurality of sub-intervals;
generating, by the one or more processing circuits from a combination of comparing the intermediate outputs of different ones of the multiple modalities for each of the plurality of sub-intervals and comparing each of modalities of the intermediate outputs for the plurality of sub-intervals, control inputs for an electro-mechanical control system;
providing the control inputs to the electro-mechanical control system; and
controlling of the autonomous system by the electro-mechanical control system in response to the control inputs.

16. The method of claim 15, further comprising:
determining the emitted modalities of the electromagnetic sensor signal based on the multiple modalities of the electromagnetic sensor signal as sensed over the period of time.

17. The method of claim 15, wherein:
comparing the intermediate outputs of different ones of the multiple modalities for each of the plurality of sub-intervals includes performing a majority voting between the different ones of the multiple modalities for each of the plurality of sub-intervals; and
comparing each of modalities of the intermediate outputs for the plurality of sub-intervals includes performing a majority voting between the modalities of the intermediate outputs for the plurality of sub-intervals.

18. A control system for autonomously operable equipment, comprising:
one or processing circuits configured to:
receive, from a sensor system, multiple modalities of each of a plurality of sensor signals as sensed over a period of time;
perform, for each of the corresponding multiple modalities the corresponding sensor signals as sensed over the period of time, majority voting between the multiple modalities for each of a plurality of sub-intervals of the period and majority voting for each of the multiple modalities between different times of the period; and
based on a combination of the majority voting between the multiple modalities for each of the sub-intervals and the majority voting for each of the multiple modalities between differ times of the period for each of the corresponding sensor signal voting, generate and provide control inputs for an electro-mechanical control system for the autonomously operable equipment.

19. The control system of claim 18, further comprising:
the sensor system, wherein each of the sensor system is configured to emit the multiple modalities of the sensor signals over the period of time during which the autonomously operable equipment is in operation and to sense the multiple modalities the sensor signals over the period of time.

20. The control system of claim 19, wherein the one or more processing circuits are further configured to determine the emitted modalities of the electromagnetic sensor signal based on the multiple modalities of the electromagnetic sensor signal as sensed over the period of time.
